(19) United States
(12) Patent Application Publication
(10) Pub. No.: US 2013/0020941 A1
(43) Pub. Date: Jan. 24, 2013

(54) Semiconductor Lamp

(71) Applicants: Nicole Breidenassel, Bad Abbach (DE); Guenter Hoetzl, Regensburg (DE); Christoph Mahler, Illertissen (DE); Thomas Preuschl, Sinzing (DE); Steffen Tegethoff, Pentling (DE)

(72) Inventors: Nicole Breidenassel, Bad Abbach (DE); Guenter Hoetzl, Regensburg (DE); Christoph Mahler, Illertissen (DE); Thomas Preuschl, Sinzing (DE); Steffen Tegethoff, Pentling (DE)

(73) Assignee: OSRAM AG, Muenchen (DE)

(21) Appl. No.: 13/581,319

(22) PCT Filed: Mar. 22, 2011
(86) PCT No.: PCT/EP2011/054373

§ 371 Date: Aug. 27, 2012

(30) Foreign Application Priority Data
Apr. 7, 2010 (DE) 102010003690.0
Jun. 30, 2010 (DE) 102010030702.5

(51) Int. Cl. H05B 33/08

(52) U.S. Cl. 315/113

(57) ABSTRACT

In various embodiments, a semiconductor lamp may include a driver cavity for accommodating driver electronics, and a light source substrate populated with at least one semiconductor light source, said driver cavity being closed by the light source substrate.

The invention relates to a semiconductor lamp having a driver cavity for accommodating driver electronics, and a light source substrate populated with at least one semiconductor light source.

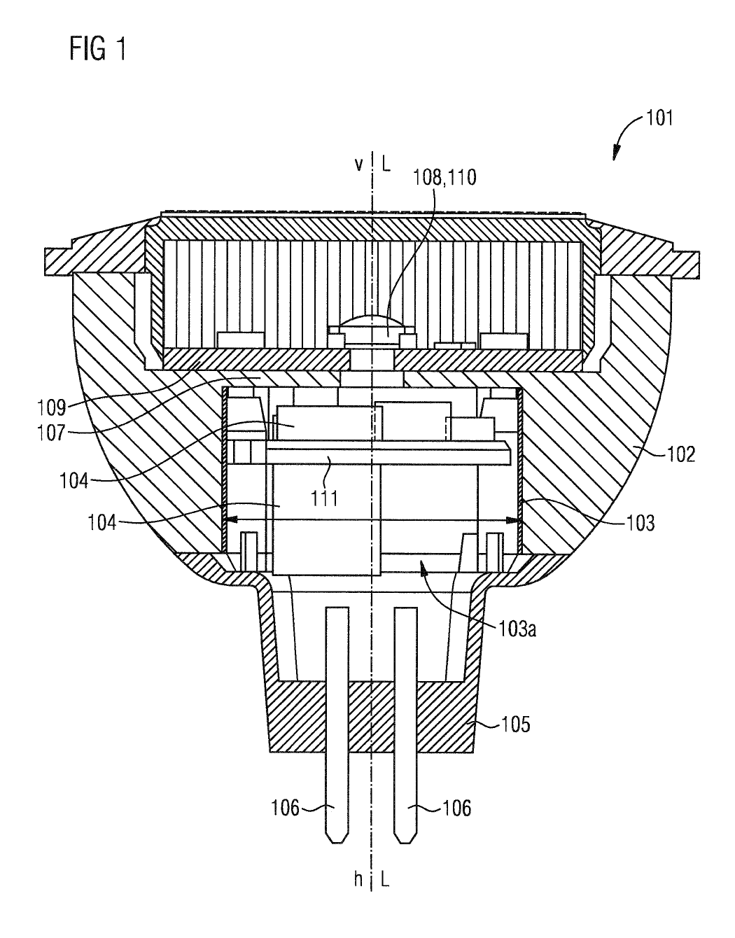

As shown in FIG. 1, a known LED retrofit lamp 101 has a heat sink 102 which has a driver cavity 103 for accommodating driver electronics 104. The driver cavity 103 has a rear opening 103a which is closed by a base 105. The base 105 has electrical contacts 106 in order to establish an electrical connection between a lamp holder (not shown) and the driver electronics 104. At the front, the driver cavity 103 is closed by a base plate 107 incorporated in the heat sink 102; the back side of the base plate 107 therefore constitutes a wall of the driver cavity 103, while its front side supports an LED module. The LED module has a substrate 109 and at least one light-emitting diode (LED) 110, the at least one light-emitting diode 110 being disposed on the front side of the substrate 109 and the back side of the substrate 109 lying flat against the base plate 107. The substrate 109 can be implemented as a circuit board. To supply power to the LEDs 110, a cable entry (not shown) is provided in the base plate 107. The driver electronics 104 are therefore located on the other side of the base plate 107 from the LED(s) 110 inside the common heat sink 102.

The driver electronics 104 can only be inserted in the driver cavity 103 from behind h through the opening 103a. The outer contour of retrofit lamps is additionally subject to regulations which require that the cross-sectional area of retrofit lamps reduces toward the base, i.e. the electrical contact. If for esthetic, production-related or thermal reasons, for example, a parting line between an upper lamp section and a lower lamp section is placed as low as possible (as in the example shown here between the heat sink 102 and the base 105), the surface area of a driver electronics circuit board 111 carrying the driver electronics 104 must be correspondingly small so that it can always be introduced from behind h into the rear opening 103a for assembly. In many cases either particular functionalities of the driver electronics 104 must then be foregone, or the LED retrofit lamp 101 must be lengthened to the front v in order to accommodate driver electronics 104 of greater height in the heat sink. In the latter case, the required outer contour of the LED retrofit lamp 101 can in some circumstances no longer be maintained.

The object of the present invention is to provide a means of accommodating even a comparatively large driver in a compact semiconductor lamp, in particular a retrofit lamp.

This object is achieved according to the features of the independent claims. Preferred embodiments are in particular set forth in the dependent claims.

The object is achieved by a semiconductor lamp having a driver cavity for accommodating a driver and a light source substrate populated with at least one semiconductor light source, the driver cavity being closed by the light source substrate.

The advantage of this semiconductor lamp is that, because there is no base plate, the driver board can now be inserted from the front into the driver cavity where, particularly in the case of a housing that narrows toward the back, a larger opening is available than in the case of conventional insertion in the region of the rear base. This means that even a full functionality driver with a wide driver board can be accommodated in a compact lamp.

The driver may also be termed the driver electronics, driver circuit, driver logic, control circuit, etc. and is used in particular to convert the electric power supplied via the base into electrical signals suitable for controlling the at least one semiconductor light source. The driver electronics may include a plurality of electronic components which are disposed in particular on a common driver board.

The driver cavity can also be described as a hollow space for accommodating the driver.

The at least one semiconductor light source preferably includes at least one light-emitting diode. If more than one light-emitting diode is present, these can emit in the same color or in different colors. A color can be monochromatic (e.g. red, green, blue, etc.) or multichromatic (e.g. white). The light produced by the at least one light-emitting diode can also be infrared light (IR-LED) or ultraviolet light (UV-LED). A plurality of light-emitting diodes can produce a mixed light, e.g. a white mixed light. The at least one light-emitting diode can contain at least one wavelength-converting phosphor (conversion LED). The at least one light-emitting diode can be present in the form of at least one individually packaged light-emitting diode or in the form of at least one LED chip. A plurality of LED chips can be mounted on a common substrate (“submount”). The at least one light-emitting diode can be equipped with at least one separate and/or common optical system for beam guidance, e.g. at least one Fresnel lens, collimator, etc. Instead of or in addition to inorganic light-emitting diodes, e.g. based on InGaN or AlInGaP, organic LEDs (OLEDs, e.g. polymer OLEDs) can also generally be used. Diode lasers, for example, can also be used. Alternatively, the at least one light source can have e.g. at least one diode laser or another semiconductor light source.

The light source substrate can be in particular a circuit board.

In one embodiment, the semiconductor lamp has two mutually attachable housing sections and at least one of the housing sections at least partially encloses the driver cavity. The driver cavity can therefore be formed by a single housing section or by both housing sections. The housing sections can be interconnected simply by attaching them together, and the driver cavity can thus be closed in a correspondingly simple manner.

In other words, the semiconductor lamp can have a common cavity for accommodating a driver and a light source substrate populated with at least one semiconductor light source, wherein the common cavity is formed by two separable/mutually attachable housing sections, in particular housing sections implemented as a heat sink. A rear housing section contains the base, while a front housing section has a light transmission aperture. This semiconductor lamp achieves the stated object even on its own.

It is particularly advantageous if neither of the two housing sections has a partition (e.g. the base plate 8) against which the entire back surface of the light source substrate rests and which conducts heat from the at least one semiconductor light source to the heat sink.

In a development, a parting line is perpendicular to a main emission direction of the light or to a longitudinal axis of the semiconductor lamp, in particular parallel to the plane of the light source substrate.

In another embodiment, the housing sections are implemented as heat sinks, a front heat sink having at least one light transmission aperture and a rear heat sink having a base (region) or being connected thereto, thereby enabling particularly simple assembly to be achieved. Thermal effects of the driver and the at least one semiconductor light source can also be minimized in this way, as heat from the more strongly heating heat sink, in particular the front heat sink, is transmitted more poorly to the less strongly heating heat sink and the driver mounted in the less strongly heating heat sink is therefore subject to less heating by the light source, at least one its side facing away from the light source.

In another embodiment, particularly the rear heat sink at least partially encloses the driver cavity. The rear heat sink is therefore in particular mainly or wholly used to accommodate the driver, while the front heat sink is used primarily to close the driver cavity and cool the light source(s).

In another embodiment, at least one of the heat sinks has projections, in particular cooling fins or cooling struts, etc. which extend over the other heat sink. For example, in particular the projections of the front heat sink, which significantly cools the light source, project in a finger-like or crenellated manner above the rear heat sink which significantly cools the driver. This provides a good compromise between a sufficiently large, in particular electrically insulated driver cavity and a large cooling surface for the front heat sink which frequently has to dissipate more heat than the rear heat sink. In a development, both heat sinks have projections aligned in the direction of the respective other heat sink that engage one another in a comb-like manner, thus increasing the thermal convection of both heat sinks.

The projections can also serve as fastening lugs, e.g. by being designed as clip contacts. The fastening functions of the two heat sinks or housing sections can also be implemented in other ways, e.g. by a circumferentially projecting rim.

In yet another embodiment, the front heat sink includes at least one material having a thermal conductivity of at least 10 W/(m·K), e.g. containing Al, Cu or alloys thereof, with ceramics, or thermally conductive plastic.

In another embodiment, the rear heat sink includes an electrically insulating material with a thermal conductivity of at least 0.5 W/(m·K). In this case the driver does not need to be electrically insulated by an additional plastic sleeve or foils, which improves the cooling of the driver components. In a variant, however, the rear heat sink can also be made of a standard plastic material.

In another embodiment, the two housing sections fix the light source substrate between them, thus enabling the light source substrate to be fastened in a secure and simple manner. For simple fastening, the light source substrate can in particular be clamped or pressed in between the housing sections. The cavity jointly enclosed by the two housing sections in one approach is then subdivided by the light source substrate into a front area with the at least one semiconductor light source and a rear area containing the driver.

In a preferred specific embodiment for effective heat dissipation, the front heat sink is in surface contact with the light source substrate, in particular with the front side thereof carrying the at least one semiconductor light source. This contact area is made as wide as possible around the at least one semiconductor light source and possibly associated optical elements in order to optimize heat transfer from the light source substrate to the front heat sink.

In yet another embodiment, the front heat sink is in surface contact with the light source substrate via a thermally conductive material (TIM; “Thermal Interface Material”) in order to improve heat transfer to the heat sink still further. The TIM can be e.g. a phase-change TIM, a thermally conductive adhesive, a TIM tape and/or a thermal transfer foil. Alternatively, the light source substrate can also be a flexible substrate which is laminated onto the front heat sink.

In another development, the rear heat sink is in essentially point and/or linear contact with the light source substrate. The contact between the light source substrate and the rear heat sink is thus minimized in order to minimize a thermal connection between the at least one semiconductor light source and the rear heat sink and therefore thermal stress for critical driver components (integrated components, electrolytic capacitors, etc.) caused by heating on the part of the at least one semiconductor light source.

The light source substrate can be implemented, for example, as a metal core circuit board, ceramic circuit board, suitably designed FR4 circuit board and/or flexible circuit board (flex). For thermal optimization of heat transfer from the at least one semiconductor light source through the light source substrate into the front heat sink, it is preferred in the case of an FR4 circuit board material that at least one double-layer, preferably more than double-layer, circuit board be used as the light source substrate, wherein a copper layer is preferably at least 75 μm thick and/or has thermal vias (through-holes) around the semiconductor light source(s) and/or throughout the contact area between the FR4 circuit board and front heat sink. If a metal core circuit board is used, particularly when using an electrically insulating TIM to optimize heat transfer from the metal core circuit board into the front heat sink, a solder resist can be dispensed with in the region of the contact.

In a further embodiment, one of the housing sections at least partially encloses the driver cavity and the light source substrate is attached to the other housing section (in particular the front heat sink), e.g. glued using a thermal adhesive or a TIM tape. This means that the light source substrate can be pre-mounted on the other housing section and does not need to be specially aligned during assembly of the housing sections. In particular, it enables direct contact between the light source substrate and the rear heat sink or similar to be avoided

In another embodiment, the light source substrate is thermally insulated from the housing section enclosing the driver cavity, e.g. by a thermally insulating layer and/or by an air gap. As a result, the driver accommodated in the driver cavity can be shielded from the heat dissipated from the at least one light source, or vice versa.

In yet another embodiment, a driver board populated with at least part of the driver electronics is accommodated essentially parallel to the light source substrate in the driver cavity (or more specifically in the rear area of the common cavity). This makes it possible to place hotter electronic components on the side of the light source substrate facing away from the driver board, thereby preventing local hotspots on the light source substrate. It also makes it possible to place the thermally sensitive electronic components on the side facing away from the light source substrate, thereby minimizing the heating of these components by the semiconductor light source(s).

In another embodiment, the front side of the light source substrate is populated with the at least one semiconductor light source and the back side of the light source substrate with at least part of the driver electronics, thereby providing a particularly compact design.

In a further embodiment, a driver board populated with at least part of the driver electronics is a circuit board designed to flex. This enables the driver board to be accommodated in the driver cavity in a particularly compact manner, e.g. also circumferentially on the side walls thereof.

The driver board can be formed integrally with the light source substrate, e.g. as a circuit board populated with the at least one semiconductor light source and the driver devices. This produces a particularly compact and component-saving design. The at least one semiconductor light source and the driver devices are preferably disposed on different sides of the circuit board, which particularly in the case of a flexible circuit board produces a particularly compact design.

In another embodiment, at least one connecting contact of the semiconductor lamp is electrically connected to a driver board populated with at least part of the driver electronics via at least one pressfit connector.

In a variant, in particular, contact pins or male contacts can be brought out linearly in the base of the rear heat sink and make contact with the driver board and/or the light source substrate by means of a pressfit connection.

In another development, the front heat sink is of at least partially reflecting design in the region of its light transmission opening(s) or cutout(s), e.g. has a reflective coating, thus providing a saving of an optical component and the assembly thereof.

Alternatively, at least one optical element (lens, reflector, etc.) can be irreversibly inserted, in particular clamped into the front heat sink and e.g. conceal screws used to bolt together the two heat sinks in order, for example, to make it impossible for a user to open the lamp without destroying it.

In a variant, screws for assembling the semiconductor lamp can be dispensed with completely, the front heat sink, the rear heat sink and the light source substrate being merely glued and/or clamped together, for example.

The semiconductor lamp is preferably a retrofit lamp, in particular an incandescent lamp retrofit lamp or a halogen lamp retrofit lamp.

The invention will now be described in greater detail with reference to exemplary embodiments schematically illustrated in the figures. For the sake of clarity, elements that are identical or produce identical effects are provided with the same reference characters.

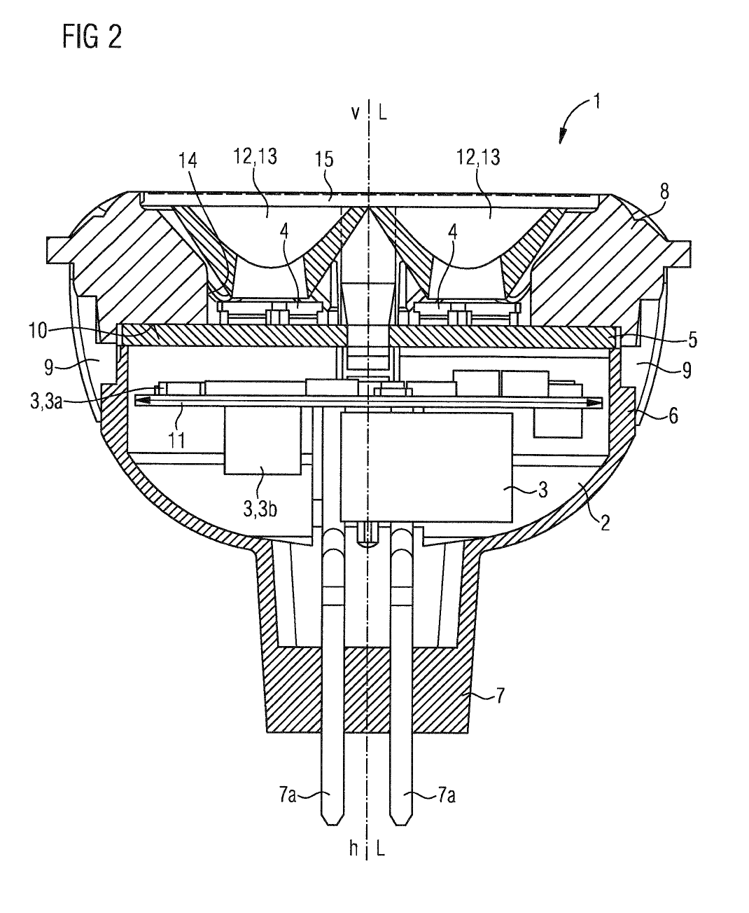

FIG. 2 shows a sectional side view of an inventive semiconductor lamp according to a first embodiment;

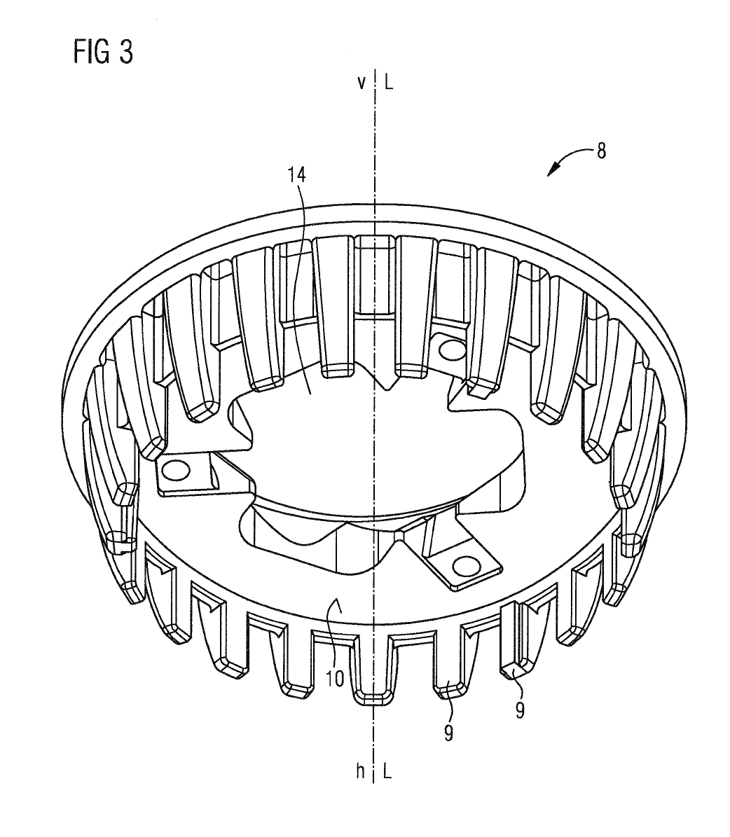

FIG. 3 shows an oblique view of a front heat sink of the semiconductor lamp according to the first embodiment;

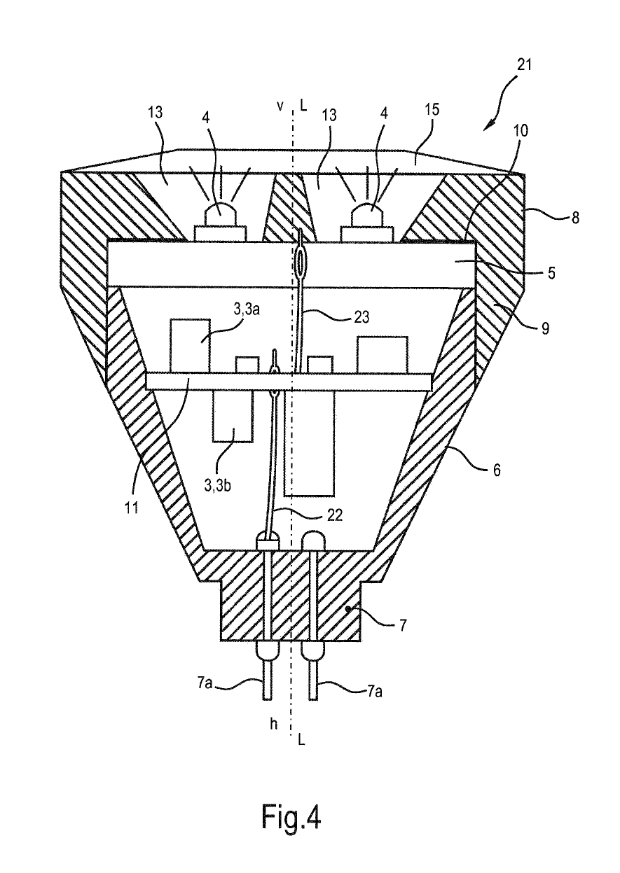

FIG. 4 shows a sectional side view of an inventive semiconductor lamp according to a second embodiment;

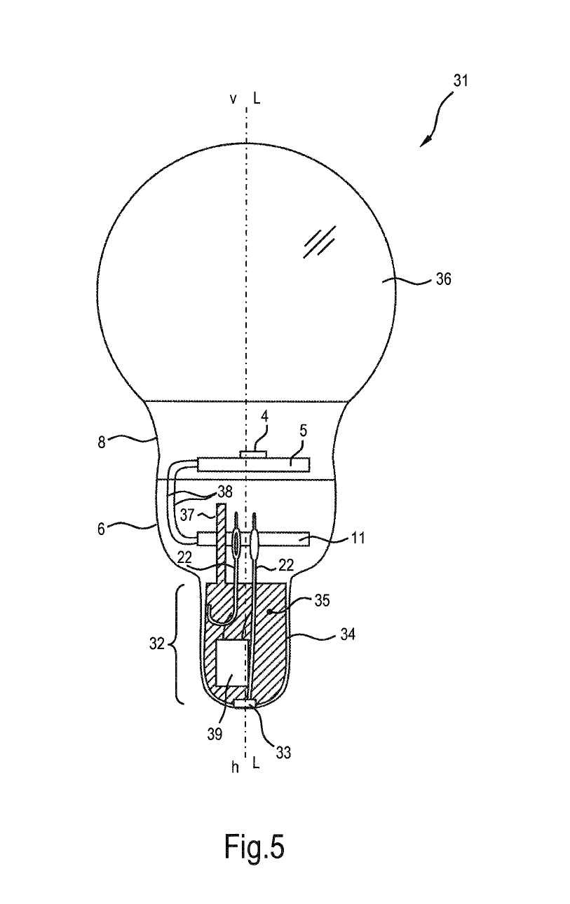

FIG. 5 shows a sectional side view of an inventive semiconductor lamp according to a third embodiment;

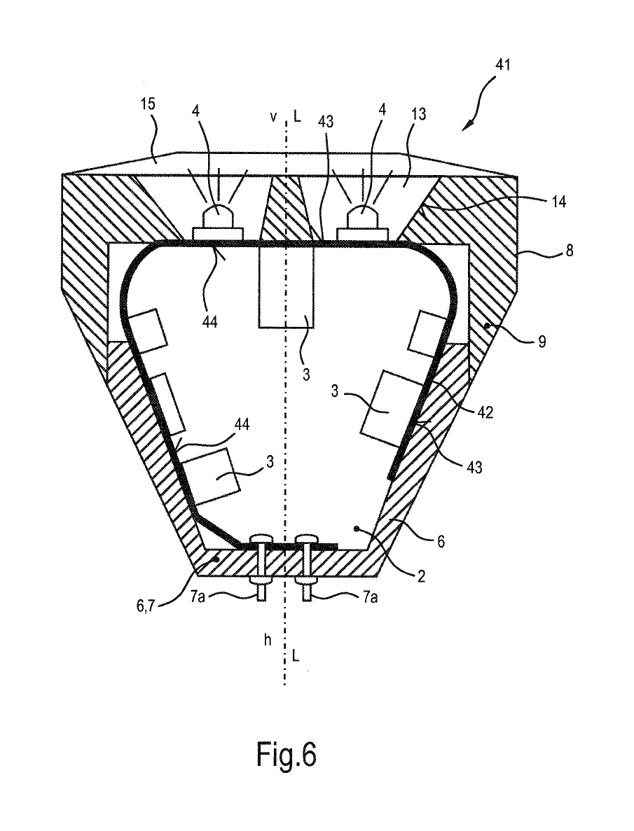

FIG. 6 shows a sectional side view of an inventive semiconductor lamp according to a fourth embodiment; and

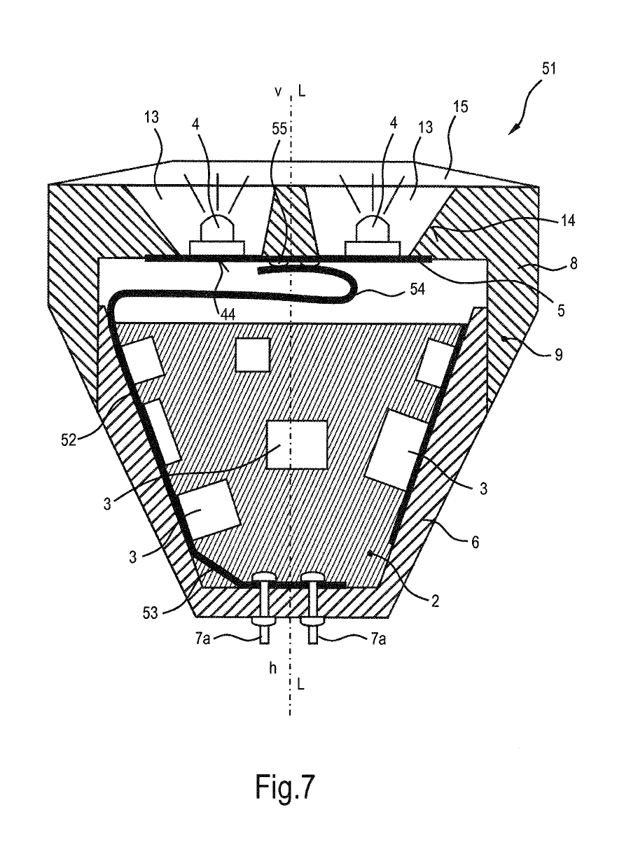

FIG. 7 shows a sectional side view of an inventive semiconductor lamp according to a fifth embodiment.

FIG. 2 shows a sectional side view of an inventive semiconductor lamp according to a first embodiment in the form of a halogen lamp retrofit lamp. The semiconductor lamp 1 has a driver cavity 2 for accommodating driver electronics 3, and a light source substrate 5 (here a metal core circuit board) populated with at least one semiconductor light source in the form of a plurality of LEDs 4. The driver cavity 2 is formed inside the rear heat sink 6 or rather enclosed thereby. The driver cavity 2 is delimited to the rear h by a base region 7 of the rear heat sink 6 and closed to the front v by the light source substrate 5. Provided on the base region 7 are two pin contacts 7a leading to the driver electronics 3 and supplying it with voltage. The driver electronics 3 in turn drive the LEDs 4.

Attached onto the rear heat sink 6 from the front v is a front heat sink 8, so that the light source substrate 5 is clamped between the front heat sink 8 and the rear heat sink 6 and thus fixed in place. For effective cooling and to achieve a secure seating on the rear heat sink 6, the front heat sink 8 has a plurality of cooling fins 9 spaced equidistantly apart on its circumferential side which project to the rear h and serve as clamping elements in respect of the rear heat sink 6. Additionally or alternatively, the rear heat sink 6 and the front heat sink 8 can be e.g. glued, locked and/or screwed together.

The edge region 10 of the front heat sink 8 shown in an oblique view in FIG. 3 lies against the front side of the light source substrate 5 over a large area in order to allow a high heat transfer therefrom for cooling the LEDs 4, possibly via a thermally conductive material (not shown). However, the rear heat sink 6 is in contact with the back of the light source substrate 5 only with its narrow upper edge (essentially corresponding to a linear contact) in order to minimize heat transfer to itself and therefore to the driver cavity 2.

A driver board 11 populated with the driver electronics 3 lies essentially parallel to the light source substrate 5 in the driver cavity 2. Consequently, the driver electronics 3 can be disposed such that driver devices 3a that are neither sensitive nor themselves produce a high heat emission are disposed on a side of the driver board 11 facing the light source substrate 5. This prevents overheating of the sensitive driver devices by the LEDs 4 or rather the light source substrate 5 as well as overheating of the light source substrate 5 locally in the region of a strongly heat-emitting driver device. The sensitive and/or strongly heat-dissipating driver devices 3b can be disposed on the back side of the driver board 11 facing away from the light source substrate 5.

The front heat sink 8 has at least one light transmission aperture 14 into which the LEDs 4 are inserted from below. Also inserted in turn into the light transmission aperture 14 from the front is a reflector 12 with a plurality of LED-specific reflector regions 13 in order to be able to selectively shape the light emission of the semiconductor lamp 1. This produces an optical axis or rather main emission direction along a longitudinal axis L of the semiconductor lamp 1. The front heat sink 8 and the reflector 12 can be covered by a translucent cover plate 15 with or without an optical function (lens function, diffuser, etc.).

The front heat sink 8 essentially consists of a material with a thermal conductivity of at least 10 W/(m·K). This material can be electrically conductive and be e.g. an aluminum alloy. Because the driver electronics 3 generate less heat, the rear heat sink 6 can be in particular an electrically insulating material with a thermal conductivity of at least 0.5 W/(m·K), e.g. plastic.

During assembly of the semiconductor lamp 1, the driver 3, 11 can be inserted into the driver cavity 2 via a large-area front side, so that the driver 3, 11 does not therefore need to be limited in size and can be comparatively freely designed. Thus in particular a powerful driver 3, 11 can be provided. This method of assembly therefore eliminates the size restriction hitherto resulting from its insertion through the rear base region.

The populated light source substrate 5 can then be placed onto the front opening of the rear heat sink 6, followed by attachment of the front heat sink 8 to the rear heat sink 6. Alternatively, the populated light source substrate 5 can be glued to the front heat sink 8 and then mounted together therewith on the rear heat sink 6.

The semiconductor lamp 1 can also be described in terms of the front heat sink 8 and the rear heat sink 6 forming a common cavity which has the light transmission apertures 14 toward the front. Accommodated in the common cavity are both the populated light source substrate 5 and the driver 3, 11, the driver board 11 subdividing the common cavity into a rear area and a front area.

FIG. 4 shows a sectional side view of an inventive semiconductor lamp 21 according to a second embodiment. The semiconductor lamp 21 has a similar basic construction to the semiconductor lamp 1. However, press-fit pins 22 which project forward in a self-supporting manner from the base region 7 are now provided as electrical links (e.g. as an alternative to wires or similar) between the base region 7 and the driver board 11. When the driver board 11 is inserted, it is seated on the press-fit pins 22 using corresponding hollow vias. Similarly, the driver board 11 can have upwardly projecting press-fit pins 23 which can produce an interference fit with a hollow via of the light source substrate 5 when the light source substrate 5 is mounted on the rear heat sink 6. The press-fit connection allows particularly simple assembly.

FIG. 5 shows a sectional side view of a semiconductor lamp 31 in the form of an incandescent lamp retrofit lamp. For this purpose, the semiconductor lamp 31 can in particular comply with the form factor of an incandescent lamp and e.g. have an essentially truncated-sphere-shaped bulb 36. The base region or base 32 is here implemented as an Edison base having a central electrical contact 33 on a rear tip and a screw thread 34 as the second electrical contact. Emerging from the central electrical contact 33 and also laterally from the screw thread 34 is in each case a press-fit pin 22 which projects forward from the base 32. The press-fit pins 22 can be routed e.g. to the driver board 11 which is in turn electrically connected to the light source substrate 5 via further press-fit pins or in some other manner, e.g. by cables 38. The base 32 shown is optionally filled with an electrically insulating potting compound 35 in order to provide it with higher mechanical stability. Electrical and/or electronic components 39 such as capacitors, resistors, ICs, etc. can be optionally embedded in the potting compound 35, thereby allowing an even more compact design. The potting compound 35 can also be used to form a forward projecting guide pin 37 in order to facilitate positioning of the driver board 11.

FIG. 6 shows a sectional side view of an inventive semiconductor lamp 41 according to a third embodiment. The light source substrate 5 and the driver board 11 are now present in the form of a single, in this case flexible circuit board 42. The circuit board 42 is populated on its outer side or front side 43 with the LEDs 4 and on its inner side or back side 44 with the driver devices 3. The flexible circuit board 42 is bent about an axis perpendicular to the longitudinal axis L such that the LEDs 4 project upward into the light transmission aperture 14 and the driver devices 3 are aligned inward in the direction of the driver cavity 2. The contact pins 7a extending through the base region 7 can be connected directly to the circuit board 42. Such a design is particularly compact and can be implemented using a comparatively small number of components. For example, separate connecting elements between the driver board and the light source substrate can be dispensed with.

FIG. 7 shows a sectional side view of an inventive semiconductor lamp 51 according to a fourth embodiment. The semiconductor lamp 51 has the light source substrate 5 and the driver board 52 as separate components. Said driver board 52 is implemented as a flexible circuit board and is disposed rotated about the longitudinal axis L in the driver cavity 2, lying flat against the walls of said driver cavity 2 for effective heat dissipation. By means of a lower loop 53, it can be connected directly to the contact pins 7a, and by means of an upper loop 54 to the light source substrate 5, e.g. via pads 55. This likewise achieves a compact and low-cost design in which the positioning of the light source substrate 5 and driver board 52 can now be carried out separately.

The present invention is self-evidently not limited to the examples shown.

For example, features of the different embodiments are additionally or alternatively interchangeable.

### LIST OF REFERENCE CHARACTERS

1 semiconductor lamp
2 driver cavity
3 driver electronics/driver chip
4 LED
5 light source substrate
6 rear heat sink
7 base region
7a pin contact
8 front heat sink
9 cooling fin
10 edge region
11 driver board
12 reflector
13 reflector region
14 light transmission aperture
15 cover plate
21 semiconductor lamp
22 press-fit pin
23 press-fit pin
31 semiconductor lamp
32 base/base region
33 contact
34 screw thread
35 potting compound
36 bulb
37 guide bolt
38 cable
39 component
41 semiconductor lamp
42 circuit board
43 front side
44 back side
51 semiconductor lamp
52 driver board
53 lower loop
54 upper loop
55 pad
101 LED retrofit lamp
102 heat sink
103 driver cavity
103a opening
104 driver electronics
105 base
106 contact
107 base plate
109 substrate
110 LED
111 driver electronics
L longitudinal axis
h rear
V front

1. A semiconductor lamp, comprising:
a driver cavity for accommodating driver electronics, and
a light source substrate populated with at least one semiconductor light source,
said driver cavity being closed by the light source substrate.

2. The semiconductor lamp as claimed in claim 1,
wherein the semiconductor lamp has two mutually attachable housing sections and at least one of the housing sections at least partially encloses the driver cavity.

3. The semiconductor lamp as claimed in claim 2,
wherein the housing sections are implemented as heat sinks,
wherein a front heat sink has at least one light transmission aperture and a rear heat sink has a base or is connected thereto.

4. The semiconductor lamp as claimed in claim 3,
wherein the rear heat sink at least partially encloses the driver cavity.

5. The semiconductor lamp as claimed in claim 3,
wherein at least one of the heat sinks has projections, which extend over the other heat sink.

6. The semiconductor lamp as claimed in claim 3,
wherein the front heat sink has at least one material with a thermal conductivity of at least 10 W/(m·K) and the rear heat sink an electrically insulating material with a thermal conductivity of at least 0.5 W/(m·K).

7. The semiconductor lamp as claimed in claim 2,
wherein the two housing sections fix the light source substrate between them.

8. The semiconductor lamp as claimed in claim 3,
wherein the semiconductor lamp has two mutually attachable housing sections and at least one of the housing sections at least partially encloses the driver cavity;
wherein the two housing sections fix the light source substrate between them;
wherein the front heat sink is in surface contact with the light source substrate and the rear heat sink is in essentially at least one of point contact and linear contact with the light source substrate.

9. The semiconductor lamp as claimed in claim 8,
wherein the front heat sink is in surface contact with the light source substrate via a thermally conductive material.

10. The semiconductor lamp as claimed in claim 2,
wherein one of the housing sections at least partially encloses the driver cavity and the light source substrate is attached to the other of the housing section and is thermally insulated from the housing section enclosing the driver cavity.

11. The semiconductor lamp as claimed in claim 1,
wherein a driver board populated with at least part of the driver electronics is accommodated essentially parallel to the light source substrate in the driver cavity.

12. The semiconductor lamp as claimed in claim 1,
wherein a front side of the light source substrate is populated with the at least one semiconductor light source and the back side of the light source substrate is populated with at least part of the driver electronics.

13. The semiconductor lamp as claimed in claim 1,
wherein a driver board populated with at least part of the driver electronics is a circuit board designed to flex.

14. The semiconductor lamp as claimed in claim 1,
wherein at least one connecting contact of the semiconductor lamp is electrically connected to a driver board populated with at least part of the driver electronics via at least one pressfit connector.

15. The semiconductor lamp as claimed in claim 5,
wherein projections comprise cooling fins which extend over the other heat sink.
